(19) United States
(12) Patent Application Publication
(10) Pub. No.: US 2006/0097646 A1
(43) Pub. Date: May 11, 2006

(54) Circuit breaker for warming lamps

(76) Inventor: Ki-Joo Kim, Gimhae-si (KR)

Correspondence Address: SCHMEISER OLSEN & WATTS, 18 E UNIVERSITY DRIVE, SUITE # 101, MESA, AZ, 85201, US

(21) Appl. No.: 11/269,317

(22) Filed: Nov. 7, 2005

(30) Foreign Application Priority Data
Nov. 9, 2004 (KR) 10-2004-0090806

(51) Int. Cl. H01J 1/60

(52) U.S. Cl. 315/129

(57) ABSTRACT

A circuit breaker for warming lamps mounted in a livestock barn is disclosed. The circuit breaker includes a housing divided into symmetrical housing parts, through which a power supply cable and a power output cable pass, and which are combined into a single body through ultrasonic fusion welding. A power switch is exposed outside the housing, while a micro switch is mounted in the housing. An ON/OFF actuator to actuate the micro switch is mounted in the housing. A warming lamp is connected to the ON/OFF actuator and is also connected to the power supply through both the power switch and the micro switch. A spring is provided in the housing such that, when the ON/OFF actuator is biased downwards by the weight of the warming lamp, the spring is compressed, and, when the weight of the warming lamp is removed from the spring, the spring extends to bias the ON/OFF actuator upwards. The circuit breaker, having a simple structure, increases work efficiency in the assembly of its parts, maximizes productivity, reduces production costs, and reduces its weight and volume. The housing has a hermetically sealed structure to prevent water from infiltrating into the housing, thereby solving the problems caused by conduction of electricity from the circuit breaker.

### BACKGROUND OF THE INVENTION

1. Field of the Invention

The present invention relates generally to circuit breakers or no fuse breakers for warming lamps used in livestock barns and, more particularly, to a circuit breaker for warming lamps, which has a simple mechanical structure to automatically cut off the power supply to the warming lamp when a lamp having the circuit breaker falls onto the bottom of a livestock barn because an animal pulls the lamp or because a clamp to secure the lamp to a desired place in the livestock barn has corroded with age, so that the circuit breaker can prevent the generation of sparks due to a short circuit of a power supply line regardless of whether the lamp breaks, thus preventing a fire from being caused in the barn by the sparks, or the animals from being killed by electric shocks, and which increases work efficiency in the assembly of the parts of the circuit breakers because the circuit breakers have a simple structure, thus maximizing productivity, reducing production costs, and lessening the weight and volume of the circuit breakers.

2. Description of the Related Art

Generally, livestock barns, such as pig barns, cowsheds and chicken houses, are equipped with a plurality of warming lamps to heat young animals, for example, piglets, calves, and chicks, thus keeping the young animals warm and promoting the growth and development of the young animals.

In the related art, halogen lamps have been preferably used as warming lamps installed in the livestock barns because halogen lamps can provide multiple advantages in that the halogen lamps function as a lighting unit to light the interior of the barns as well as a heat radiation unit to heat the air in the barns, and can reduce the amount of electricity consumed. However, halogen lamps are expensive, so that, in an effort to reduce the costs of the warming lamps, cheap incandescent lamps have been used as warming lamps to be installed in livestock barns.

The halogen lamps and the incandescent lamps, which have been preferably used as warming lamps for livestock barns due to the above-mentioned advantages, are typically covered with protective shades thereon to efficiently reflect and radiate light from the lamps to young animals, thus promoting the growth and development of the young animals. The shades also protect the lamps from external impacts. The halogen lamps and the incandescent lamps (herein below, the two types of lamps will be referred to simply as “warming lamps” without distinction therebetween) are positioned to be as close to the animals as possible in the winter season so as to maximize the lamps' effect of warming young animals. Described in detail, in the winter season, the warming lamps are suspended at considerably low heights of about 30-50 cm over the bottom of a livestock barn. Furthermore, because the young animals grow very quickly and may touch the warming lamps out of curiosity, the warming lamps have been configured such that the heights of the suspended lamps over the bottom of a livestock barn can be adjusted by adjusting the lengths of the lamp connection wires that connect the warming lamps to circuit breakers.

Because the warming lamps covered with the protective shades are typically suspended at low heights over the bottom of a livestock barn as described above, the curious young animals in the livestock barn may bite or peck at the lamps and shades and pull the lamps and shades with their mouths for fun. Thus, the animals sometimes break the lamps and shades. Furthermore, a fastening clamp, which secures the warming lamp to a desired place in the livestock barn, easily corrodes with age so that the lamp may fall off the clamp and be broken. When the warming lamps are broken as described above, the power supply lines of the lamps may break, thereby causing a short circuit and generating sparks, and emitting electricity from the lines. Thus, a fire may be caused in the barn by the sparks, or the animals may be killed by electric shocks.

Furthermore, because curious young animals grow very quickly, so that the young animals may easily touch the lamps and shades as described above, farmers must repeatedly and frequently adjust the heights of the warming lamps over the bottom of the livestock barn and make the positions of the lamps higher and higher by repeatedly and frequently adjusting the lengths of the lamp connection wires that connect the lamps to circuit breakers. However, the farmers may absentmindedly forget to adjust the heights of the lamps over the bottom, or may consciously decide not to undertake the work of adjusting the heights of the lamps over the bottom of a livestock barn due to the troublesome nature of the work, in which the farmers must manually adjust the heights of the lamps over the bottom by adjusting the lengths of the lamp connection wires one by one. When the adjustment of the heights of the lamps over the bottom is ignored, the livestock barns may catch fire or the animals bred in the barns may be killed by electric shocks.

Of course, in an effort to overcome the above-mentioned problems, the warming lamps may be suspended from the ceiling at higher positions where the animals cannot touch the lamps or shades. However, the warming lamps suspended at the higher positions are problematic in that the lamps cannot provide the same operational effects, such as the effect of warming the animals, as those expected from lamps placed at lower positions.

If the warming lamps are broken by animals as described above, the power supply to the warming lamps must be cut off to prevent a fire from breaking out in the livestock barn. To achieve the above-mentioned object, several types of conventional circuit breakers for warming lamps have been proposed and used.

An example of conventional circuit breakers will be described herein below with reference to the accompanying drawings.

FIG. 1 is a perspective view illustrating a conventional circuit breaker according to an embodiment of the related art, with a warming lamp connected to the circuit breaker. FIG. 2 is a partially broken, exploded perspective view of the conventional circuit breaker according to the embodiment of the related art. FIG. 3 is a partially broken perspective view of the conventional circuit breaker according to the embodiment of the related art, showing the parts of the circuit breaker in an assembled state.

As shown in the drawings, the conventional circuit breaker for warming lamps comprises a housing 10 which has a power switch 30 to supply power to a warming lamp 1 (described precisely, this lamp 1 unit a lamp unit comprising a lamp and a shade, but, for ease of description, the lamp unit will be referred to simply as a “lamp” herein below). A hanging ring 10a is integrally formed on the upper surface of the housing 10 and mounts the housing 10 to the ceiling or wall of a livestock barn. A micro switch bracket 40 is provided in the housing 10 to mount a micro switch 50 to the interior of the housing 10, such that the micro switch 50 is mounted in the housing 10 using the micro switch bracket 40. An ON/OFF actuator 60 is connected to the warming lamp 1 by unit of a lamp connection wire W and actuates an ON/OFF button 52 of the micro switch 50. A base plate 80 is placed on the bottom of the housing 10 and supports the ON/OFF actuator 60, with a spring boss 82 to receive a spring 70 therein provided in the base plate 80.

The above-mentioned construction of the circuit breaker will be described in detail herein below.

First, the power supply relationship will be described. The supply of power to a warming lamp 1 is accomplished by the operation of both the conventional power switch 30, provided on the outer surface of the circuit breaker, and the micro switch 50. Thus, the first end of the power switch 30 protrudes from a sidewall of the housing 10, while the second end of the power switch 30, which is placed in the housing 10, is connected to the power ON/OFF terminal plate 32. A power supply cable 34 is electrically connected to each of the power ON/OFF terminal plate 32 and the micro switch 50. Furthermore, a power output cable 36, which is electrically connected to both the power ON/OFF terminal plate 32 and the micro switch 50, extends outside the housing 10 and is connected to the warming lamp 1.

Hereinbelow, the internal construction of the housing 10 will be described.

The micro switch bracket 40 is mounted to the inner surface of the upper wall of the housing 10 using two locking bosses 15 formed on the inner surface of the upper wall. In the above state, the micro switch bracket 40 comprises an upper locking plate part 45, which has two locking holes 42, corresponding to the two locking bosses 15, and a guide hole 43 formed between the two locking holes 42. A lower locking plate part 49 integrally extends from the upper locking plate part 45 and has two locking bosses 47 which are formed at upper and lower positions.

The micro switch 50, which is mounted to the micro switch bracket 40, is a conventional micro switch, with two locking holes 54 formed in the body of the switch 50 to correspond to the locking bosses 47 of the lower locking plate part 49. An ON/OFF button 52 is provided on the upper surface of the body of the micro switch 50. Two connection terminals 56 and 58 for a power supply cable 34 and a power output cable 36 are provided on the lower surface and a side surface of the body of the micro switch 50, respectively.

Furthermore, the ON/OFF actuator 60 to operate the ON/OFF button 52 of the micro switch 50 comprises a guide rod 62, which is guided along a guide hole 43 formed in the micro switch bracket 40, and a round contact part 64, which is provided below the guide rod 62 and is brought into contact with the ON/OFF button 52 of the micro switch 50. The ON/OFF actuator 60 further comprises a wire locking plate 67, which defines an opening between the wire locking plate 67 and the contact part 64 to avoid interference with the body of the micro switch 50. A wire locking hole is formed in the lower part of the wire locking plate 67, so that a lamp connection wire W having a stopper S at an end thereof passes through the wire locking hole and extends to the warming lamp 1.

The base plate 80 of the housing 10 comprises a plate member, with protrusions 80a provided on each of opposite side surfaces of the plate member and inserted into locking holes (not shown) formed on opposite side surfaces of the housing 10, thus preventing the base plate 80 from being undesirably removed from the housing 10. A cylindrical spring boss 82 protrudes upwards from the center of the base plate 80 and receives a spring 70 therein and, at the same time, allows the lamp connection wire W to pass therethrough.

In a normal state, the spring 70 is compressed by the weight of the warming lamp 1. However, when the weight of the warming lamp 1 is removed from the spring 70, the spring 70 extends to bias the ON/OFF actuator 60 upwards.

The conventional circuit breaker for warming lamps having the above-mentioned construction is advantageous in that, when animals pull the lamps down onto the bottom of a livestock barn and break the lamps, the circuit breaker can automatically cut off the power supply to the warming lamps, thus preventing fire from being started in the livestock barn by the sparks or preventing animals from being killed by electric shocks.

However, the conventional circuit breaker for warming lamps has a complex construction, so that work efficiency in the assembly of the parts of the circuit breaker is reduced, thereby deteriorating productivity. Described in detail, the housing 10 comprises an integral body and a base plate 80 which is detachably mounted to the bottom of the body. Thus, in the assembly of the parts of the circuit breaker, all the parts must be inserted into the housing 10 upwards one by one through the lower opening of the housing 10 and, thereafter, must be assembled in desired places, so that work efficiency is reduced. Furthermore, the micro switch bracket 40 and the micro switch 50 must be mounted at desired locations in the housing 10 using locking members 40a and 50a, thus requiring excessive time to mount the micro switch bracket 40 and the micro switch 50.

Another problem of the conventional circuit breaker for warming lamps resides in that the junction between the housing 10 and the base plate 80 is not sealed or maintained in a waterproof state, so that electricity may be conducted from the circuit breaker to the outside due to moisture infiltration into the circuit breaker.

Furthermore, when the animals pull and break the warming lamp 1, the circuit breaker can automatically cut off the power supply to the warming lamp 1. However, water may infiltrate into the circuit breaker of the warming lamp 1, thus conducting electricity from the circuit breaker and causing the animals to be killed by electric shocks.

Furthermore, several types of circuit breakers for warming lamps other than the above-mentioned conventional circuit breakers have been proposed and used, but they cannot solve the problems of the above-mentioned circuit breakers.

### SUMMARY OF THE INVENTION

Accordingly, the present invention has been made keeping in mind the above problems occurring in the prior art, and an object of the present invention is to provide a circuit breaker for warming lamps, which is supported to the ceiling or sidewall of a livestock barn using a hanging ring formed on the upper surface of a housing of the circuit breaker, and which has a simple construction and does not require separate locking member fastening work of locking the parts to the housing, thereby maximizing work efficiency and productivity in the assembly of the parts of circuit breakers, reducing production costs, and reducing the weight and volume of the circuit breakers.

Another object of the present invention is to provide a circuit breaker for warming lamps, which has a hermetically sealed structure to prevent water from infiltrating into the housing of the circuit breaker, thus solving the problems associated with conduction of electricity from the circuit breaker.

A further object of the present invention is to provide a circuit breaker for warming lamps, which has an integral structure so that, once the circuit breaker is completely assembled, the circuit breaker cannot be disassembled, thus being semi-permanently usable.

In order to accomplish the above objects, the present invention provides a circuit breaker for warming lamps installed in a livestock barn, comprising: a housing divided into two symmetrical housing parts, each of which has a power supply cable inlet port and a power output cable outlet port, and which are combined with each other into a single body through ultrasonic fusion welding; a power switch provided on the housing and exposed outside the housing; a micro switch mounted in the housing; an ON/OFF actuator mounted in the housing and actuating the micro switch; a warming lamp connected to the ON/OFF actuator and connected to a power supply through both the power switch and the micro switch; and a spring provided in the housing such that, when the ON/OFF actuator is biased downwards due to the weight of the warming lamp, the spring is compressed, and when the weight of the warming lamp is removed from the spring, the spring extends to bias the ON/OFF actuator upwards. The circuit breaker according to the present invention has a simple construction and does not require separate locking member fastening work of locking the parts to the housing, thereby maximizing work efficiency and productivity in the assembly of the parts of the circuit breaker, reducing production costs, and reducing the weight and volume of the circuit breaker. Furthermore, the circuit breaker has a hermetically sealed structure to prevent water from infiltrating into the housing of the circuit breaker, thus solving the problems associated with conduction of electricity from the circuit breaker.

In the circuit breaker for warming lamps according to the present invention, the ON/OFF actuator may be placed in the housing to come into contact with the micro switch through a contact unit during movement of the ON/OFF actuator along guide plates in the housing. The contact unit may comprise a tapered surface formed on the ON/OFF actuator and an elastic arm and a roller to come into contact with an ON/OFF button of the micro switch, thus allowing the micro switch to execute correct ON/OFF operation.

In the circuit breaker for warming lamps according to the present invention, the spring may be placed in a spring seat provided in the ON/OFF actuator and supported by a spring stopper formed between the guide plates, so that the spring can be compressed by the ON/OFF actuator or can extend to bias the ON/OFF actuator upwards, thereby automatically cutting off power supply to the warming lamp if the lamp is broken.

In the circuit breaker for warming lamps according to the present invention, a spring holding protrusion may be provided in the upper end of the spring seat to prevent the spring from being undesirably removed from the spring seat, thus preventing breakage of the circuit breaker caused by displacement of the spring.

Furthermore, in the circuit breaker for warming lamps according to the present invention, the power switch may be held at a desired position in the housing by support plates, holding plates, and upper and lower support pieces, while the micro switch may be securely held in the housing by support pins, support plates and holding plates, thus being prevented from undesirably moving in the housing and being less likely to break. Furthermore, a cover, made of a sealing material, may be provided on the power switch, thus preventing foreign substances from infiltrating into the power switch.

Furthermore, the junction surfaces of the two symmetric divided housing parts of the circuit breaker for warning lamps according to the present invention may be provided with locking protrusions and locking slots, respectively, thus increasing the fastening strength of the housing and, at the same time, increasing work efficiency in the assembly of the parts of the housing. Furthermore, each of the power supply cable inlet port and the power output cable outlet port of the housing may be provided with at least one protrusion therein to prevent the power supply cable or the power output cable from slipping in the inlet and outlet port.

Furthermore, the circuit breaker for warming lamps according to the present invention may further comprise an alarm unit for generating an alarm sound or turning on an alarm lamp to inform a user of a power cutoff state in response to a signal from a sensing unit which senses the power cutoff state when the ON/OFF actuator comes into contact with the micro switch, by which the micro switch is turned off to cut off the power supply to the warming lamp.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view illustrating a conventional circuit breaker according to an embodiment of the related art, with a warming lamp connected to the circuit breaker;

FIG. 2 is a partially broken, exploded perspective view of the conventional circuit breaker according to the embodiment of the related art;

FIG. 3 is a partially broken perspective view of the conventional circuit breaker according to the embodiment of the related art, with the parts of the circuit breaker in an assembled state;

FIG. 4 is a perspective view illustrating a circuit breaker for warming lamps according to an embodiment of the present invention, showing the parts in an assembled state;

FIG. 5 is an exploded perspective view of the circuit breaker for warming lamps according to the embodiment of the present invention;

FIGS. 6A and 6B are plan views illustrating left-side and right-side housings, respectively, of the circuit breaker for warming lamps according to the embodiment of the present invention;

FIG. 7 is a circuit diagram of the circuit breaker for warming lamps according to the embodiment of the present invention;

FIG. 8 is a perspective view of the circuit breaker according to the present invention, with a warming lamp connected to the circuit breaker;

FIG. 9A is a sectional view illustrating the circuit breaker according to the present invention in a power supply state; and

FIG. 9B is a sectional view illustrating the circuit breaker according to the present invention in a power cutoff state.

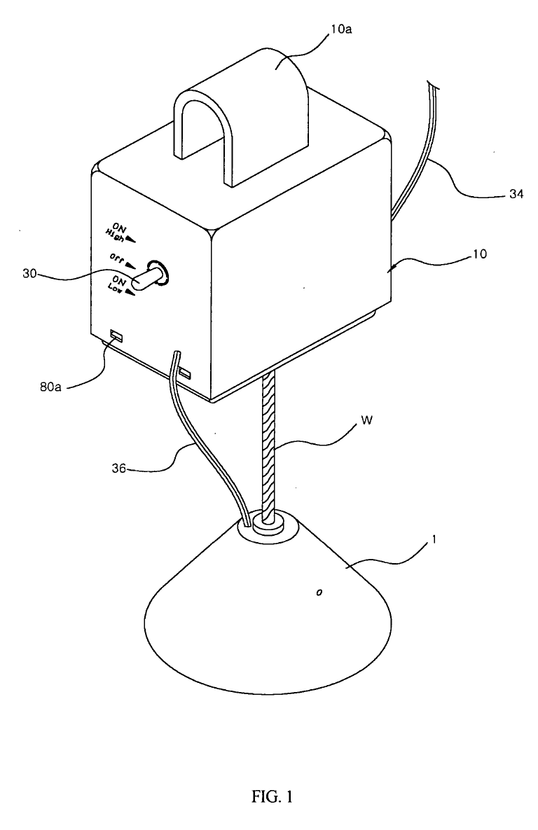

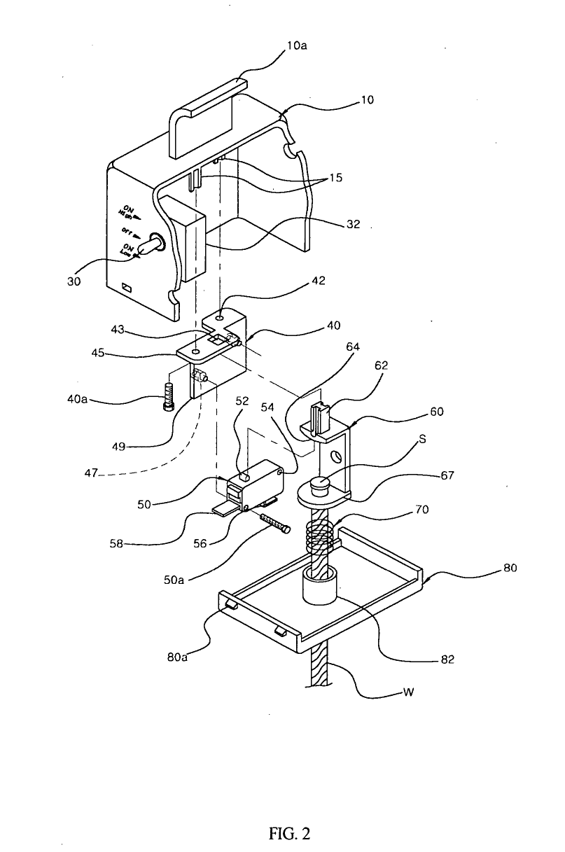

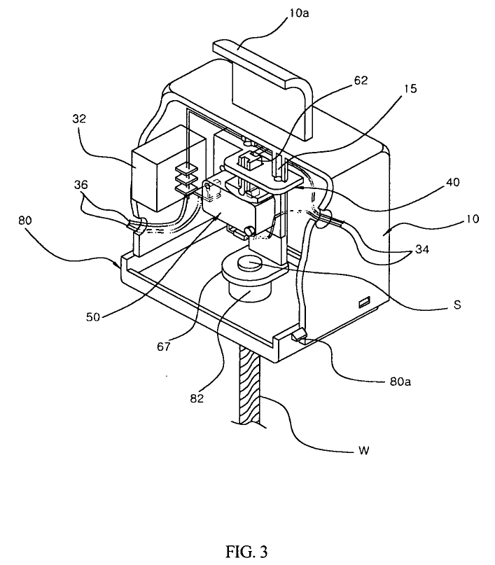

### DESCRIPTION OF THE PREFERRED EMBODIMENTS

Reference now should be made to the drawings, in which the same reference numerals are used throughout the different drawings to designate the same or similar components.

Herein below, a preferred embodiment of the present invention will be described in detail with reference to the accompanying drawings.

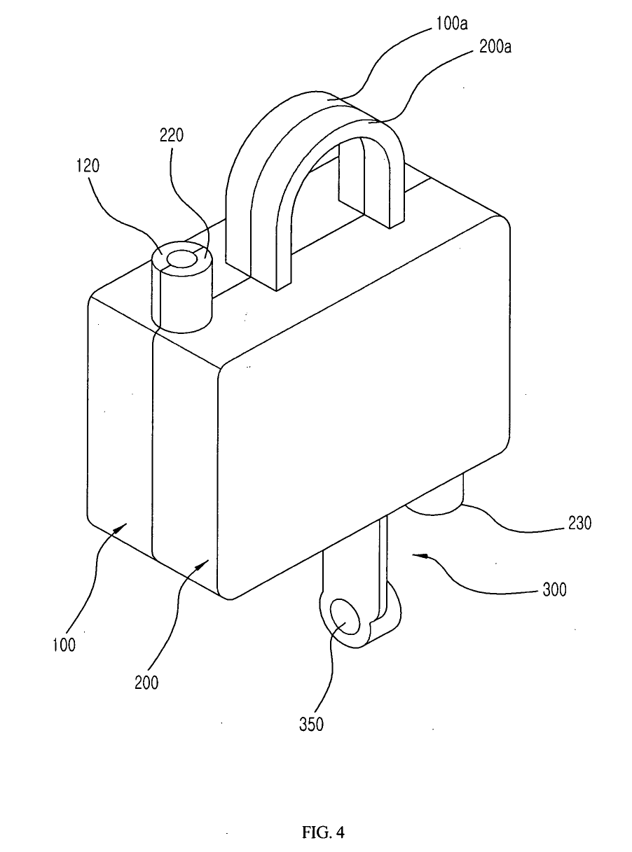

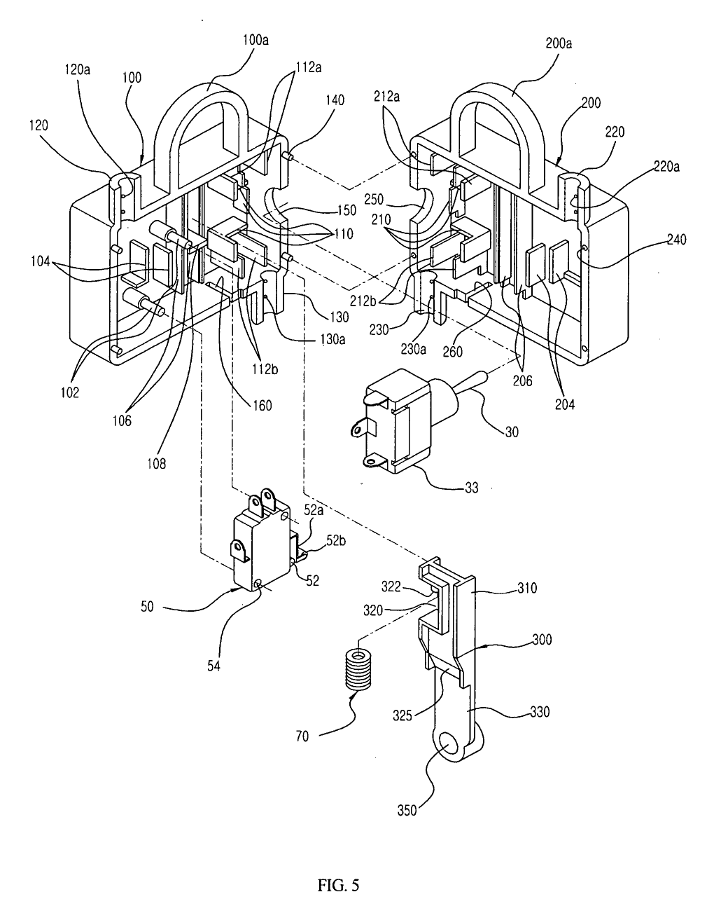

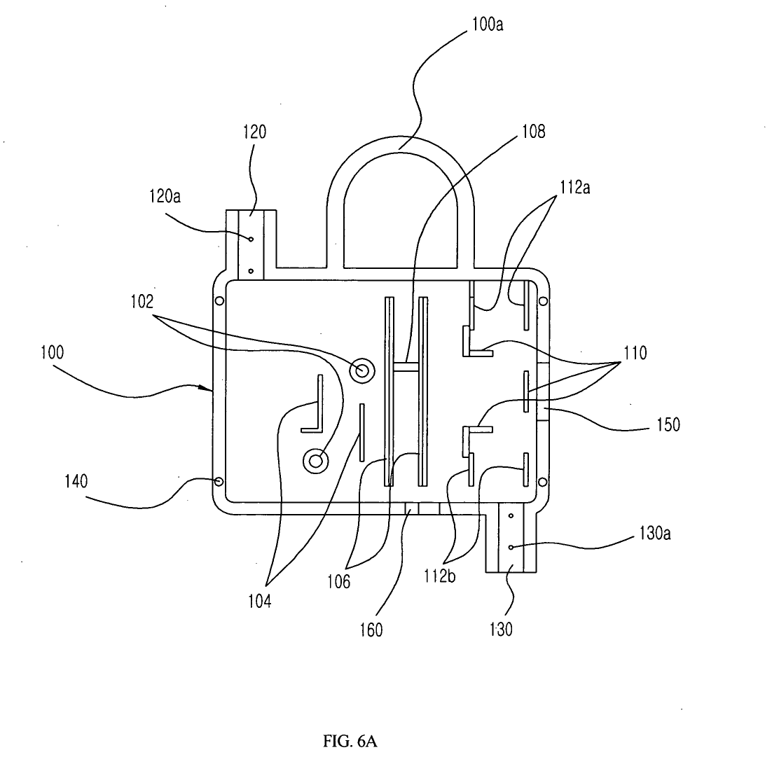

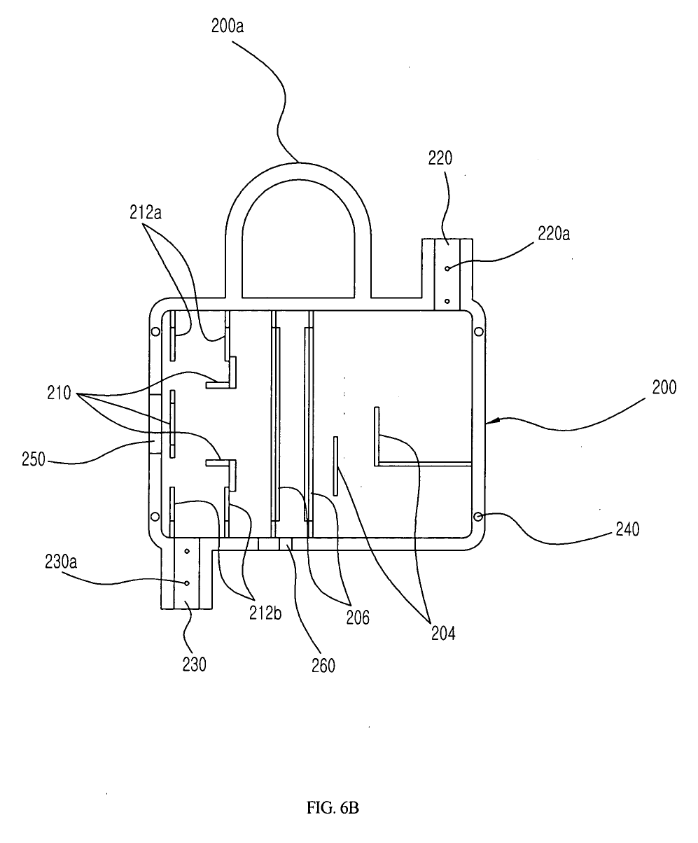

FIG. 4 is a perspective view illustrating a circuit breaker for warming lamps according to an embodiment of the present invention, showing the parts in an assembled state. FIG. 5 is an exploded perspective view of the circuit breaker for warming lamps according to the embodiment of the present invention. FIGS. 6A and 6B are plan views illustrating left-side and right-side housing parts, respectively, of the circuit breaker for warming lamps according to the embodiment of the present invention.

The circuit breaker for warming lamps according to the embodiment of the present invention will be described in detail herein below with reference to the drawings.

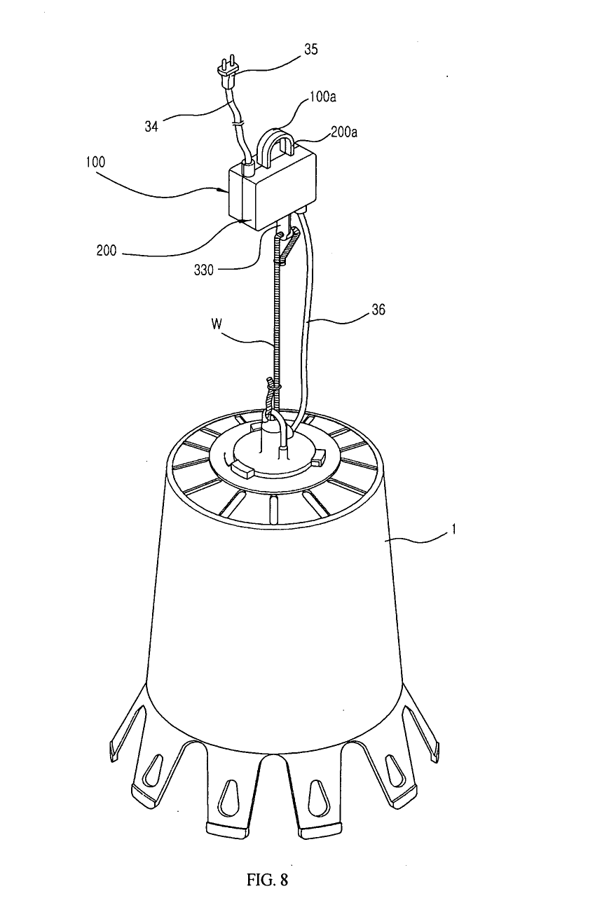

The circuit breaker for warming lamps according to the present invention comprises a housing, which is symmetrically divided into a left-side housing part 100 and a right-side housing part 200, with a power switch 30 provided on the housing to supply power to or cut off the power supply to a warming lamp 1 (see FIG. 8), preferably selected from halogen lamps or incandescent lamps.

In the circuit breaker, a first hanging ring 100a is integrally formed on the upper surface of the left-side housing part 100, with two support pins 102 formed on the inner surface of the sidewall of the left-side housing part 100 and supporting a micro switch 50 on a desired place in the housing. Each of the two support pins 102 is configured such that the lower part of each pin 102 from the intermediate portion to the root end is thicker than the upper part, thus efficiently supporting the micro switch 50. Furthermore, two support plates 104 to support the micro switch 50 are formed in the left-side housing part 100 at positions between the two support pins 102, thus increasing the strength of support of the micro switch 50. In addition, two first guide plates 106 are formed at positions in the right side of the support pins 102, with a spring stopper 108 protruding from the first housing part 100 at a position between the two first guide plates 106. Three support plates 110, defining a triangular arrangement, are provided at positions in the right side of the first guide plates 106 and support the body 33 of the power switch 30. In addition, first upper and lower support pieces 112a and 112b protrude outside the support plates 110 and support the body 33 of the power switch 30, thus preventing the body 33 from undesirably moving.

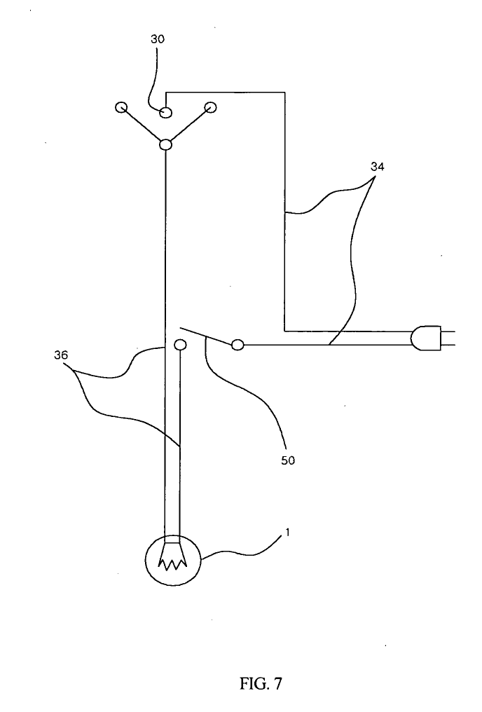

A first semicylindrical inlet port 120 is formed at a predetermined position of the upper surface of the left-side housing part 100, thus allowing a power supply cable 34 (see FIGS. 7 and 8) to pass through the inlet port 120. A first semicylindrical outlet port 130 is formed at a predetermined position of the lower surface of the left-side housing part 100, so that a power output cable 36 (see FIGS. 7 and 8) can pass through the first semicylindrical outlet port 130. Four locking protrusions 140 protrude from the junction surface of the left-side housing part 100, with a first semicylindrical notch 150 formed on an intermediate portion of part of the junction surface and allowing the power switch 30 to pass outwards. A first slit 160 is formed in the lower part of the left-side housing part 100 at a predetermined position close to the first guide plates 106, so that an ON/OFF actuator 300 to operate an ON/OFF button 52 of the micro switch 50 can be inserted.

The right-side housing part 200 has a construction similar to that of the left-side housing part 100, but the two housing parts 100 and 200 are symmetrical with respect to each other. The right-side housing part 200 is configured as follows.

At a predetermined position of the upper surface of the right-side housing part 200, a second hanging ring 200a corresponding to the first hanging ring 100a of the left-side housing part 100 is integrally formed. At predetermined positions of the inner surface of the right-side housing part 200, two holding plates 204 are provided to compress and hold the micro switch 50 in cooperation with the two support plates 104 of the left-side housing part 100. In the left side of the two holding plates 204, two second guide plates 206 are formed on the right-side housing part 200 such that the guide plates 206 correspond to the two first guide plates 106 of the left-side housing part 100.

Furthermore, in left side of the second guide plates 206, three holding plates 210 are formed to compress and hold the body 33 of the power switch 30 in cooperation with the support plates 110 of the left-side housing part 100. Second upper and lower support pieces 212a and 212b protrude from the inner surface of the right-side housing part 200 at positions outside the holding plates 210, thus supporting the body 33 of the power switch 30 such that the body 33 cannot be undesirably moved.

Furthermore, at a predetermined position of the upper surface of the right-side housing part 200, a second semicylindrical inlet port 220, which corresponds to the first semicylindrical inlet port 120 of the left-side housing part 100, is formed. In addition, a second semicylindrical outlet port 230, which corresponds to the first semicylindrical outlet port 130 of the left-side housing part 100, is formed at a predetermined position of the lower part of the right-side housing part 200. The junction surface of the right-side housing part 200 is provided with four locking slots 240 that engage with the four locking protrusions 140 of the left-side housing part 100. Furthermore, at an intermediate position on the junction surface, a second semicylindrical notch 250 is formed such that the notch 250 corresponds to the first semicylindrical notch 150 of the left-side housing part 100. A second slit 260, which corresponds to the first slit 160 of the left-side housing part 100, is formed in the lower part of the right-side housing part 200 at a predetermined position around the second guide plates 206.

Herein below, the ON/OFF actuator 300, which is assembled in the housing formed by fusion-welding the left-side and right-side housing parts 100 and 200 and automatically cuts off power supply to the warming lamp 1, will be described in detail.

The ON/OFF actuator 300 comprises an upper body 310, which moves along the first guide plates 106 and second guide plates 206 of the left-side and right-side housing parts 100 and 200, and a lower body 330 which is integrally formed on the lower part of the upper body 310 and inserted into the first and second slits 160 and 260 of the left-side and right-side housing parts 100 and 200. A wire locking hole 350 to lock a lamp connection wire (see FIG. 8) is formed in the lower end of the lower body 330.

A spring seat 320 is formed in a predetermined portion of the upper body 310 and receives therein a spring 70, which is normally compressed by the weight of the warming lamp 1. However, when the weight of the warming lamp 1 is removed from the spring 70, the spring 70 elastically extends to bias the ON/OFF actuator 300 upwards. On the upper end of the spring seat 320, a spring holding protrusion 322 to hold the spring 70 is provided. Furthermore, an intermediate surface of the ON/OFF actuator 300, which is a connection surface between the upper body 310 and the lower body 330, is configured as a tapered surface 325 which is brought into contact with the ON/OFF button 52 of the micro switch 50.

In the present invention, the power switch 30 and the micro switch 50 may be selected from conventional switches, therefore a detailed description thereof is deemed unnecessary. Herein below, the operation of the circuit breaker according to the present invention to control power supply will be described.

The power supply to the warming lamp 1 is controlled by operation of both the power switch 30 and the micro switch 50 as shown in FIG. 7. Described in detail, power supply cables 34 are electrically connected to a power ON/OFF terminal plate, which is provided on the body 33 (see FIG. 5) of the power switch 30 but is not designated by any reference numeral in the drawing, and the micro switch 50, respectively. The power output cables 36, which are electrically connected to the power ON/OFF terminal plate and the micro switch 50, are connected to the warming lamp 1. The electric connection between the power switch 30, the micro switch 50 and the warming lamp 1 is well known to those skilled in the related art, therefore further explanation is deemed unnecessary.

The connection between the warming lamp and the circuit breaker having the above-mentioned construction according to the present invention will be described herein below with reference to FIGS. 5, 8, 9A and 9B.

FIG. 8 is a perspective view of the circuit breaker according to the present invention, with a warming lamp connected to the circuit breaker.

First, the two locking holes 54 of the micro switch 50 are fitted over respective support pins 102 provided on the inner surface of the left-side housing part 100, and thereafter, the micro switch 50 is seated in the space defined between the two support plates 104.

Thereafter, the ON/OFF actuator 300 is seated in the space defined between the two first guide plates 106 of the left-side housing part 100. In the above state, the upper end of the spring 70 is first fitted over the spring holding protrusion 322 provided in the upper body 310. Thereafter, the spring 70 is correctly placed in the spring seat 320. After seating the spring 70 in the spring seat 320, the upper body 310 is placed in the space between the two first guide plates 106 and, at the same time, the lower body 330 is inserted into the first slit 160 of the left-side housing part 100.

In the above state, the lower end of the spring 70 comes into close contact with the spring stopper 108 so that, when the ON/OFF actuator 300 moves upwards or downwards, the spring 70 can be compressed or can extend in a space between the spring holding protrusion 322 of the spring seat 320 and the spring stopper 108.

During downward movement of the ON/OFF actuator 300, the tapered surface 325, which is formed on the intermediate part of the ON/OFF actuator 300, is placed at a position at which the tapered surface 325 comes into contact with the ON/OFF button 52 of the micro switch 50.

When the ON/OFF actuator 300 is completely assembled in the left-side housing part 100, the body 33 of the power switch 30 is placed in the space defined between the first upper and lower support pieces 112a and 112b of the left-side housing part 100. Thus, the body 33 of the power switch 30 is supported by the three support plates 110 and is prevented from being undesirably moved. Furthermore, the power switch 30 passes outwards through the first semicylindrical notch 150 formed at the intermediate portion of the junction surface of the left-side housing part 100. In the above state, the power switch 30 is preferably combined with a waterproof cover (not shown) made of a sealing material, such as rubber.

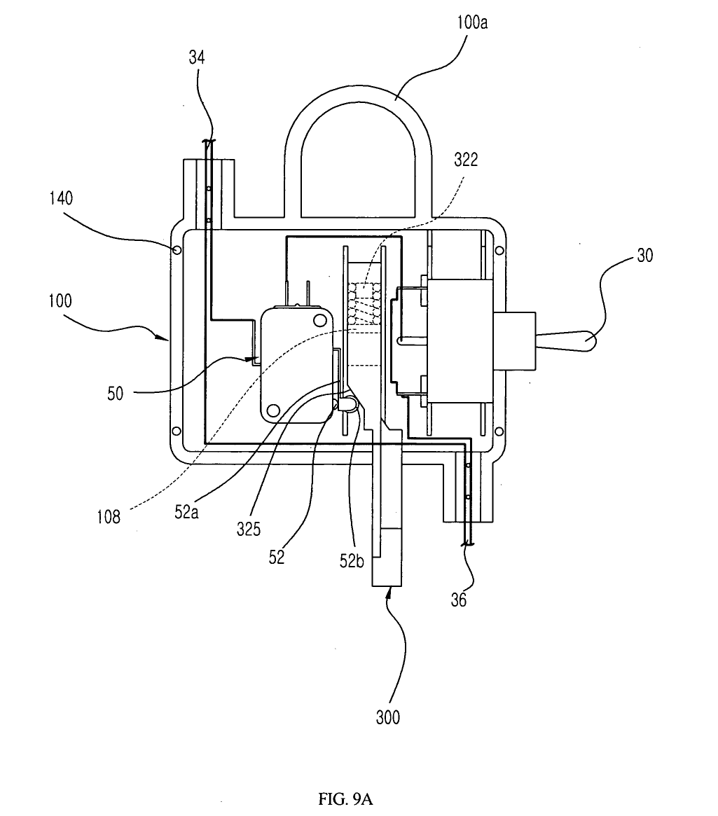

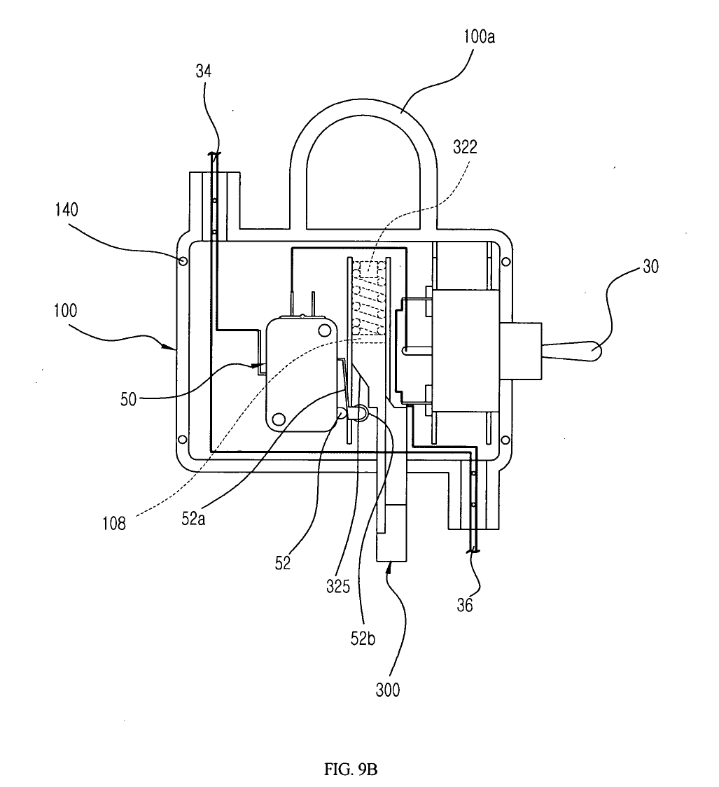

In the circuit breaker of the present invention, an electric circuit, which comprises electric cables and can selectively supply power to or cut off the power supply to the warming lamp 1 according to operation of the power switch 30 and the micro switch 50, is provided. The electric circuit, comprising a plurality of cables and electric elements, is shown in FIGS. 9A and 9B. The power supply cable 34 having a plug 35 closely passes through the first semicylindrical inlet port 120 of the left-side housing part 100, while the power output cable, connected to the warming lamp 1, closely passes through the first semicylindrical outlet port 130 of the left-side housing part 100.

When the above-mentioned electric connection is accomplished, the right-side housing part 200 is closely combined with the left-side housing part 100. The combination of the right-side housing part 200 with the left-side housing part 100 will be described herein below.

When the right-side housing part 200 is compressed to the left-side housing part 100, the four locking protrusions 140 formed on the junction surface of the left-side housing part 100 are inserted into and locked to the four locking slots 240 which are formed on the junction surface of the right-side housing part 200.

Therefore, when the assembly is finished, the second hanging ring 200a, which is exteriorly formed on the upper surface of the right-side housing part 200, is aligned with the first hanging ring 100a of the left-side housing part 100. furthermore, the two holding plates 204, which are formed on the inner surface of the right-side housing part 200, compress and securely hold the micro switch 50. Furthermore, the second guide plates 206 of the right-side housing part 200 are aligned with the first guide plates 106 of the left-side housing part 100, thus guiding movement of the ON/OFF actuator 300. In addition, the second slit 260 of the right-side housing part 200 is correctly aligned with the first slit 160 of the left-side housing part 100, thus guiding movement of the lower body 330 of the ON/OFF actuator 300.

Furthermore, the three holding plates 210 of the right-side housing part 200 are aligned with the three support plates 110 of the left-side housing part 100 and hold the body 33 of the power switch 30 in cooperation with the three support plates 110 of the left-side housing part 100. Furthermore, the second upper and lower support pieces 212a and 212b support the body 33 of the power switch 30, thus preventing the body 33 from being undesirably moved.

In addition, the second semicylindrical inlet port 220, formed on the upper surface of the right-side housing part 200, is aligned with the first semicylindrical inlet port 120 of the left-side housing part 100, thus defining an inlet port to receive the power supply cable 34 therein. In the same manner, the second semicylindrical outlet port 230 is aligned with the first semicylindrical outlet port 130 of the left-side housing part 100, thus defining an outlet port to receive therein the power output cable 36.

Furthermore, each of the first semicylindrical inlet port 120, the second semicylindrical inlet port 220, the first semicylindrical outlet port 130 and the second semicylindrical outlet port 230 is provided with at least one locking protrusion 120a, 130a, 220a or 230a, thus preventing the power supply cable 34 and the power output cable 36 from slipping in the ports.

When the left-side housing part 100 is completely combined with the right-side housing part 200, the junction surface between the left-side housing part 100 and the right-side housing part 200 is subjected to ultrasonic fusion welding, thus accomplishing a completely waterproof structure. Furthermore, as described above, the power switch 30 is combined with the waterproof cover made of a sealing material (not shown), such as rubber, so that the housing does not allow foreign substances, such as water, to infiltrate through the junction between the left-side housing part 100 and the right-side housing part 200.

When the warming lamp is completely assembled with the circuit breaker of the present invention, the circuit breaker is held to the sidewall or the ceiling of a livestock barn by fastening the hanging ring, comprising the first hanging ring 100a and the second hanging ring 200a, to a clamp (not shown) on the sidewall or a hanging loop (not shown) extending from the ceiling.

Thereafter, the upper end of the lamp connection wire W is connected to the wire locking hole 350, which is formed in the end of the lower body 330 of the ON/OFF actuator 300. The warming lamp 1 is connected to the lower end of the lamp connection wire W.

Hereinbelow, the operation of the circuit breaker for warming lamps having the above-mentioned construction according to the present invention will be described with reference to FIGS. 5, 8, 9A and 9B.

FIG. 9A is a sectional view illustrating the circuit breaker according to the present invention in a power supply state. FIG. 9B is a sectional view illustrating the circuit breaker according to the present invention in a power cutoff state.

First, the power supply state of the circuit breaker for warming lamps will be described with reference to FIG. 9A.

In a normal state, the lamp connection wire W, which suspends the warming lamp 1 as shown in FIG. 8, is pulled downwards by the weight of the warming lamp 1, so that the ON/OFF actuator 300 connected to the end of the wire W is moved downwards along the first guide plates 106 and the second guide plates 206 which are provided in the left-side and right-side housing parts 100 and 200. Thus, the spring 70, which is placed between the ON/OFF actuator 300 and the spring stopper 108, is in a compressed state.

When the ON/OFF actuator 300 is placed in a lower position as described above, the tapered surface 325 of the ON/OFF actuator 300 comes into contact with the ON/OFF button 52 of the micro switch 50, thus turning on the micro switch 50. In the present invention, to enhance the operational reliability of the ON/OFF button 52 of the micro switch 50, an elastic arm 52a is formed around the ON/OFF button 52, with a roller 52b mounted to the end of the elastic arm 52a. Thus, the roller 52b comes into sliding contact with the tapered surface 325 of the ON/OFF actuator 300. Due to the sliding contact of the roller 52b with the tapered surface 325, the elastic arm 52a is brought into contact with the ON/OFF button 52 of the micro switch 50, thus turning on the micro switch 50.

In the above state, the power switch 30 is in an ON state, so that electric current flows through the power output cable 36 which passes through the micro switch 50 and the power switch 30. Thus, the electric current is supplied to the warming lamp 1 electrically connected to the end of the power output cable 36, so that the warming lamp 1 emits heat and light.

While the warming lamp 1 is electrically activated and emits heat and light as described above, an animal, such as a pig, may pull the warming lamp 1. In the above state, the clamp, which has secured the circuit breaker of the warming lamp to a sidewall of a livestock barn, may fall off due to age, or the hanging loop, which has suspended the lamp to the ceiling of the livestock barn, may be loosened or broken by the pulling force of the animal.

In the above state, the circuit breaker of the present invention falls onto the bottom of the livestock barn along with the warming lamp 1, so that the warming lamp 1 strikes the bottom of the livestock barn and may be broken. Thus, the compression force, which has loaded the spring 70, is released from the spring 70, so that the spring 70 elastically extends to bias the ON/OFF actuator 300 upwards. Therefore, the tapered surface 325 of the ON/OFF actuator 300, which has been in contact with the ON/OFF button 52 of the micro switch 50, is moved upwards away from the ON/OFF button 52 of the micro switch 50. Thus, the micro switch 50 is turned off (see FIG. 9B)

Due to the above-mentioned operation, the power supply to the warming lamp 1 is cut off.

Of course, although the warming lamp 1 falls onto the bottom of the livestock barn, the lamp 1 may not break, but may remain in an unbroken state. However, in the unbroken warming lamp 1 on the bottom of the livestock barn, the spring 70 is released from the compression force, so that the spring 70 in the above state elastically extends to cut off the power supply to the micro switch 50.

Therefore, even if the warming lamp 1 falls onto the bottom of a livestock barn by an animal and breaks as described above, the power supply to the power output cable 36 is cut off. Thus, the circuit breaker prevents a fire from being caused in the barn by sparks, or animals from being killed by electric shocks.

Furthermore, the junction surfaces of the left-side and right-side housing parts 100 and 200 of the circuit breaker for warming lamps according to the present invention are integrated into a single structure through ultrasonic fusion welding. Thus, it is possible to prevent foreign substances, such as mud, on the bottom of the barn from infiltrating into the circuit breaker, thereby preventing conduction of electricity from the circuit breaker for warming lamps of the present invention.

Furthermore, an alarm unit may be added to the circuit breaker for warming lamps of the present invention. The alarm unit may comprise a sensing unit (sensor), which senses the falling of the warming lamp 1 onto the bottom of the livestock barn or the power cutoff state of the circuit breaker, wherein the power supply to the warming lamp is cut off, and generates an alarm sound through a speaker or turns on an alarm lamp to generate a visual alarm signal. Described in more detail, if the circuit breaker falls onto the bottom of the livestock barn along with the warming lamp 1 due to an animal, so that the spring 70 is released from the compression force of the warming lamp 1, thereby cutting off the power supply to the micro switch 50, the sensing unit senses the power cutoff state of the micro switch and generates alarm sound or turns on an alarm lamp.

The above-mentioned alarm unit is well known to those skilled in the related art, so that those skilled in the art may easily embody and modify the construction of the alarm unit without affecting the functionality of the present invention.

As described above, the present invention provides a circuit breaker for warming lamps, which is supported to the ceiling or sidewall of a livestock barn using a hanging ring formed on the upper surface of a housing, which has a simple construction, and which does not require separate locking member fastening work of locking the parts to the housing, thereby maximizing work efficiency and productivity in the assembly of the parts of circuit breakers, reducing production costs, and reducing the weight and volume of the circuit breakers.

Furthermore, the circuit breaker for warming lamps has a hermetically sealed structure to prevent water from infiltrating into the housing, thus solving the problems caused by conduction of electricity from the circuit breaker.

The circuit breaker also has an integral structure so that, once the circuit breaker is completely assembled, the circuit breaker cannot be disassembled, thus being semi-permanently usable.

Furthermore, the circuit breaker for warming lamps according to the present invention may further comprise an alarm unit which can generate an alarm sound or turn on an alarm lamp in response to the sensing operation of a sensor if the power supply to the lamp is cut off. Thus, a user can conveniently and efficiently use the circuit breaker of the present invention.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A circuit breaker for warming lamps mounted in a livestock barn, comprising:
a housing divided into symmetrical housing parts, each of which has a power supply cable inlet port and a power output cable outlet port, and which are combined with each other into a single body through ultrasonic fusion welding;
a power switch provided on the housing and exposed outside the housing;
a micro switch mounted in the housing;
an ON/OFF actuator mounted in the housing and used to actuate the micro switch;
a warming lamp connected to the ON/OFF actuator and connected to a power supply through both the power switch and the micro switch; and
a spring provided in the housing such that, when the ON/OFF actuator is biased downwards due to the weight of the warming lamp, the spring is compressed, and when the weight of the warming lamp is removed from the spring, the spring extends to bias the ON/OFF actuator upwards.

2. The circuit breaker for warming lamps according to claim 1, wherein the ON/OFF actuator is placed in the housing to come into contact with the micro switch during movement of the ON/OFF actuator along guide plates provided in the housing.

3. The a support plate circuit breaker for warming lamps according to claim 1, wherein the power switch is supported in the housing by, a holding plate, and upper and lower support pieces.

4. The circuit breaker for warming lamps according to claim 1, wherein the micro switch is supported in the housing by a support pin, a support plate and a holding plate.

5. The circuit breaker for warming lamps according to claim 1, further comprising:
an alarm unit for generating an alarm sound or turning on an alarm lamp to inform a user of a power cutoff state according to sensing operation of a sensing unit which senses the power cutoff state when the ON/OFF actuator comes into contact with the micro switch, thus turning off the micro switch and cutting off a power supply to the warming lamp.

6. The circuit breaker for warming lamps according to claim 1, wherein the symmetrical housing parts are provided with a locking protrusion and a locking slot on junction surfaces thereof.

7. The circuit breaker for warming lamps according to claim 1, wherein each of the power supply cable inlet port and the power output cable outlet port of the housing is provided with at least one locking protrusion to prevent a power supply cable or a power output cable from slipping.

8. The circuit breaker for warming lamps according to claim 2, further comprises a contact unit for the ON/OFF actuator and the micro switch comprising:
a tapered surface formed on the ON/OFF actuator; and
an elastic arm and a roller to come into contact with an ON/OFF button of the micro switch.

9. The circuit breaker for warming lamps according to claim 2, wherein the spring is placed in a spring seat provided on the ON/OFF actuator and is supported by a spring stopper provided between the guide plates, so that the spring is compressed by the ON/OFF actuator and extends to move the ON/OFF actuator upwards.

10. The circuit breaker for warming lamps according to claim 3, wherein the power switch is covered with a sealing material.

11. The circuit breaker for warning lamps according to claim 9, wherein the spring seat is provided on an upper end thereof with a spring holding protrusion to prevent the spring from being removed from the spring seat.
